(19) United States
(12) Patent Application Publication
(10) Pub. No.: US 2006/0223037 A1
(43) Pub. Date: Oct. 5, 2006

(54) Device for teaching biblical scripture and method of using the same

(76) Inventor: Ingrid Tanda, Haverhill, MA (US)

Correspondence Address: Law Offices of Michael Leccese, P.C.;Michael Leccese, Esq., Suite 202, 790 Turnpike St., North Andover, MA, 01845, US

(21) Appl. No.: 11/097,019

(22) Filed: Apr. 1, 2005

(51) Int. Cl. G09B 19/00

(52) U.S. Cl. 434/245

(57) ABSTRACT

A biblical scripture teaching device and method of using the same comprising at least a towel having a width dimension, a length dimension, a top edge, a bottom edge, a first side edge a second side edge, a front face and a rear face. A scripture display indicia is disposed thereon the front face or the rear face or front and rear face of the towel. The scripture display indicia comprising at least a full or partial text of biblical scriptures that are placed on, sawn in or embroidered within the fabric of the towel. Additionally the front face or rear face, or front and rear face may include a spiritual graphical representation such as but not limited to, praying hands, an image of god, an image of Jesus, an image of the holy land or other like images. The scripture and additional images displayed on the towel promote teaching and communication of biblical lessons and scriptures.

### FIELD

The present invention relates to a biblical scripture teaching device and method of using the same for teaching persons about scripture, more particularly, the invention relates to bathing products such as towels and bath robes constructed from water absorbent materials displaying biblical indicia or inspirational religious messages to promote teaching and communication of biblical scriptures, biblical images and inspirational massages.

### BACKGROUND

In the past, teaching and leaning biblical scripture has been undertaken in traditional ways such as reading religious scriptures in book form as well attending bible reading groups or other religious classes to further understanding of the bible and religion. Often persons do not have the time or enjoy attending these structured classes and look for other ways in which to learn and visualize biblical scripture, images, inspirational messages and indicia. It is common that reading from the bible or other books of scripture will not allow the reader to single out and remember specific passages and images; the inventor recognizes that incorporating these indicia into common towels and robes aids in biblical teachings and having this convenient teaching aid to at least promote, learning, religious conversation and reflection. Also scriptures found in the printed bible or printed form may not be practical to carry with you everywhere you go, particularly not practical in places you would normally find bath products such as towels and robes. The inventor recognizes the need and benefit to expose persons to this indicia in a way that would teach the person biblical scripture in an environment that is conformable to the person using the invention. In this respect it is often desirable to have a more accessible and convenient form of teaching aid to promote religious and inspirational thought.

Many inventors have found that teaching biblical scripture in other and inventive ways have helped persons who use them. In one prior art a soap bar that is embossed with a religious design on one side and a prayer on the other, whereby aiding the user to read and learn biblical scripture. Others include a pillow in the shape of a cross having biblical scripture imprinted thereon. Yet others include a charm necklace in the shape of a bible that has a religious message therein. All are intended to provide the user with a biblical message reference or an inspirational one.

Also many inventors have invented Christian leaning toys to aid in the leaning of scripture. Some of which include a bible looking apparatus that emits a sound from an imbedded speaker whereby the operator pushes a button on the apparatus and the sound from the audio speaker plays a scripture message such as “Thou shall not steal”, wherein the operator listens and learns the message. Other toys or Christian leaning includes board games wherein in part a playing piece is moved from location to location whereby the location having a biblical message to be learned.

None of the above inventions taken singularly or in combination is seen to describe the instant invention as claimed. Thus a towel or robe with biblical indicia thereon used for educating and leaning is present and desired,

### SUMMARY

This invention provides an apparatus and method for teaching biblical scripture to persons. More particularly, embodiment of this invention relates to a manner in which to construct and use common materials, manufacturing and teaching methods to teach persons biblical lessons more efficiently and effectively than in the past. Using embodiments and implementations of this invention will allow the user to learn and teach biblical and inspirational religious messages. Moreover, using embodiments and implementations of this invention will allow the user to teach and convey religious messages more efficiently and effectively resulting in higher learning retention and learning satisfaction without sacrificing function or appearance. This invention is directed toward learning and teaching of biblical scripture and relaying religious messages in a novel and fun approach using common bath products such as towels and bath robes. The shape and size of the invention can vary, however the traditional shape of a standard bath towel is rectangular. One advantage of teaching or exposing one self or others to scripture in this fashion in part is due to normal and every day use of such products as well as time spent with these products allowing one be exposed to bible scripture, characteristically in repeated fashion and to think, gain knowledge of and consider what is indicia is located on the towel and what this message is teaching.

Furthermore, this invention can be used or viewed in a number of ways, one of which is to place a plurality of the scripture towels in proximity to one another allowing for a plurality of messages thereon to be viewed at one time thereby allowing the user to view, remember and learn scripture, inspirational and religious messages more efficiently and effectively.

It is further object of this invention to provide an apparatus and method that is simple by design and efficient in method and use.

In one embodiment the religious indicia is affixed to a towel that is used to display the indicia as well as used as towels are normally used as absorbent apparatus. Typically, for display and decoration, having the indicia visible for teaching coupled with using the towel as an absorbent media that can be used for wiping and drying of persons and objects. The inventor also realizes that utilizing a plurality of towels in proximity to each other can be a way to convey a larger biblical message or even a biblical story. In yet another illustration of this invention the religious indicia is affixed to a bathrobe that is worn on the persons for display of the religious indicia. Typically the towel and robe can be manufactured from an Egyptian cotton fabric with the indicia embroidered or fixedly attached to the garment or towel.

Illustrative embodiments and modes of operation of this present invention have been described in this specification. The invention which is intended to be protected herein, however, is not to be construed as limited to particular embodiments disclosed, since these embodiments are to be regarded as illustrative rather then restrictive. Variations and changes made by others without departing from the spirit of this invention. Accordingly, it is expressly intended that all such variations and changes which fall within the spirit and scope of the claims be embraced thereby.

### BRIEF DESCRIPTION OF THE DRAWINGS

FIG. 1 shows a perspective view of a towel illustrating the front face of the towel having religious indicia thereon.

FIG. 2 shows a perspective view of a towel hanging over a towel bar illustrating the front face of the towel having religious indicia thereon.

FIG. 3 shows a perspective view of a plurality of towels illustrating the front faces having religious indicia thereon.

FIG. 4 shows a perspective view of the robe illustrating the face having religious indicia thereon.

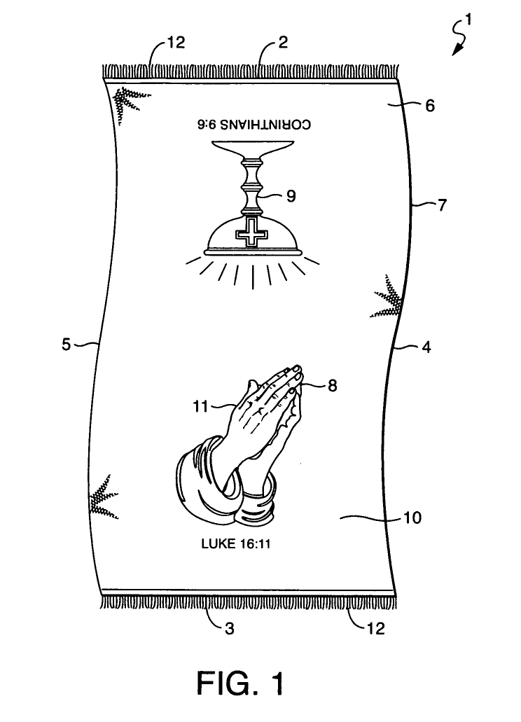

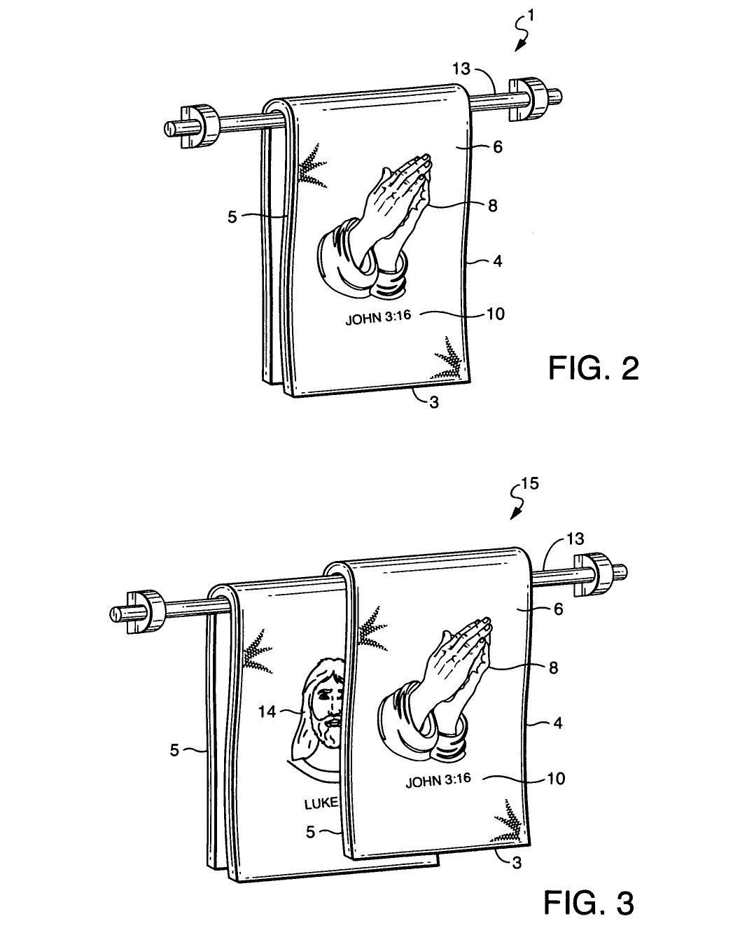

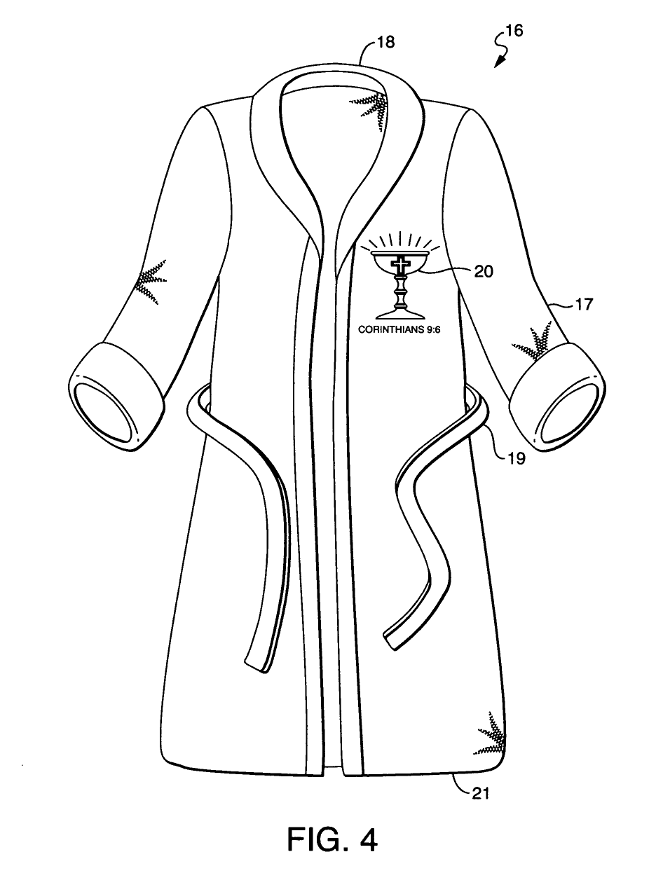

### DETAILED DESCRIPTION OF THE DRAWINGS

A biblical scripture teaching device 1 comprising, a towel having a width dimension 2, a length dimension 4, a top edge 2, a bottom edge 3, a first side edge 4, a second side edge 5, a front face 6 and a rear face 7, the front face 6 having biblical indicia 8, 9, fixedly attached thereto wherein the indicia is comprising, scriptures, scripture references 10, scripture text, scripture images, inspirational messages whereby teaching and communicating of scripture and religious images is promoted by the scripture being displayed on the towel. Typically, the front face 6 of the towel comprises the biblical indicia 8 however the rear face 7 may also contain the same. Frequently the indicia 8 markings are Christian scripture 10 and images 8,9, but can be other religious indicia. The towel normally is used to dry a person's hands, face or body after bathing and is constructed from a water absorbent material; this material can be Egyptian cotton or other similar fabrics. Other common towel construction may also be present on this invention; this construction may include a fringed edge 12 or edges or tassel edge 12 or edges. The biblical indicia 8 may be fixedly acted to the towel such that when the towel is hung over a common towel bar 13, hook or hanger where the biblical indicia 8 is visible. Also multiple towels may be positioned in relation to one another 15 so the towels show a plurality of scripture and images 8, 14.

A biblical scripture teaching device may also take the shape of a bathrobe having, a body part including sleeves 17, a collar 18, a closure means 19 and, a biblical indicia 20 fixedly attached thereto wherein the indicia comprising, scriptures, scripture references, scripture text, scripture images, inspirational messages, whereby teaching and communicating or scripture is promoted by the scripture being displayed on the robe. Frequently, the indicia markings are Christian scripture and images but can be other religious indicia. The robe normally is used as a garment that is worn by a person to display the indicia as well as a person to keep warm and dry, a person can also use the rob to dry a person's hands, face or body after bathing and is constructed from a water absorbent material; this material can be Egyptian cotton or other similar fabrics. Other common robe construction may also be present on this invention; this construction may include a fringed edge 21 or edges or tassel edge 21 or edges. The biblical scripture and image 20 may be fixedly acted to the robe such that when the robe is worn or hung over the image is visible.

What is claimed is:

1) A biblical scripture teaching device comprising:
a towel having a width dimension, a length dimension, a top edge, a bottom edge, a first side edge, a second side edge, a front face and a rear face, the front face having biblical indicia fixedly attached thereto wherein the indicia is comprising, scriptures, scripture references, scripture text, scripture images, inspirational messages whereby teaching and communicating of scripture is promoted by the scripture being displayed on the towel.

2) The biblical scripture teaching device of claim 1, wherein the rear face has biblical indicia fixedly attached thereto.

3) The biblical scripture teaching device of claim 1, wherein indicia is Christian scripture.

4) The biblical scripture teaching device of claim 1, wherein the towel is constructed of a water absorbent material.

5) The biblical scripture teaching device of claim 4, wherein the absorbent marital is Egyptian cotton.

6) The biblical scripture teaching device of claim 1, wherein the top edge and bottom edge includes a fringe such as tassel.

7) The biblical scripture teaching device of claim 1, wherein the image is fixedly acted thereto such that when the towel is hung over a towel bar the image is visible.

8) The biblical scripture teaching device of claim 1, wherein the biblical scripture teaching device includes a plurality of towels.

9) The biblical scripture teaching device of claim 8, wherein organizing the towels such that the indicia on the towels is visibly conveying a story whereby the plurality of towels story is a biblical story.

10) A biblical scripture teaching device comprising:
a bath robe having,
a body part including sleeves,
a collar,
a closure means and,
a biblical indicia fixedly attached thereto wherein the indicia comprising, scriptures, scripture references, scripture text, scripture images, scripture references and scripture text whereby teaching and communicating or scripture is promoted by the scripture being displayed on the towel.

11) The biblical scripture teaching device of claim 10, wherein the indicia is Christian scripture.

12) The biblical scripture teaching device of claim 10, wherein the robe is constructed of a water absorbent material.

13) The biblical scripture teaching device of claim 12, wherein the absorbent marital is Egyptian cotton.
